(19) United States
(12) Patent Application Publication
(10) Pub. No.: US 2015/0339368 A1
(43) Pub. Date: Nov. 26, 2015

(54) METHOD AND SYSTEMS FOR SYNCHRONIZING CONTACT INFORMATION

(71) Applicant: VONAGE NETWORK LLC, Holmdel, NJ (US)

(72) Inventor: Alexander Gruber, Brooklyn, NY (US)

(73) Assignee: VONAGE NETWORK LLC, Holmdel, NJ (US)

(21) Appl. No.: 14/282,427

(22) Filed: May 20, 2014

(51) Int. Cl. G06F 17/30

(52) U.S. Cl. CPC G06F 17/30578

(57) ABSTRACT

Methods and systems for synchronizing contact information from multiple sources across multiple devices associated with a user are provided herein. In some embodiments, a method for synchronizing contact information from multiple sources across multiple devices associated with a user may include receiving a contact modification message from a first device to modify a contact in a cloud contact address book, where the cloud contact address book includes contact information for a plurality of contacts from one or more devices associated with a user; modifying the contact in the cloud contact address book based on modification information included in the contact modification message; identifying at least one device of the plurality of devices in which the contact is a native contact; and pushing the modified contact to the identified at least one device.

### BACKGROUND

1. Field

Embodiments of the present invention generally relate to methods and systems for synchronizing (“syncing”) contact information from multiple sources across multiple devices associated with a user.

2. Description of the Related Art

An address book function, or contact directory, may include contact information about numerous contacts. Contact information generally includes information that can be used for contacting, corresponding with or otherwise communicating with a contact. Contact information may include, for example, the names, telephone numbers, e-mail addresses, mailing addresses, and other identifying information of a contact.

Typically, a user is associated with, or otherwise has access to multiple devices, with each device having its own native address book/contact directory. For example, a user may have a first device for business that includes an address book/contact directory of business contacts. The user may also have a second device for personal use that includes an address book/contact directory of personal contacts. In addition, applications installed on each device may each maintain a separate contact directory specific to the application. For example, the user may have contacts from the user's GOOGLE® GMAIL™ account, contacts from the user's MICROSOFT® Exchange account, contacts from the user's YAHOO!® account, and the like. Some applications installed on a user's device may access a cloud address book that includes an aggregated list of all contacts from all address books across all devices of the user. However, the user is generally unable to modify a contact from the aggregated list because the contact may not be native to the device where the user is viewing the aggregated list, or the contact is owned by an application other than that application providing the aggregated view of the cloud address book.

For example, a user may be viewing the aggregated list of contacts in a cloud address book using a Voice over Internet Protocol (VOIP) telecommunication app on the first device. The cloud address book includes a contact (contact X) that is native to a second device. The user may wish to modify/update contact X in the cloud address book via the first device while he is viewing the contact. Currently, when the user modifies the contact via the first device, the modified contact X may be updated in the cloud address book. However, contact X is not updated on the second device. In addition, if contact X was obtained from an internet based address book/service (e.g., GOOGLE, YAHOO!), the modified contact X is not updated on the internet based address book/service systems.

Thus, there is a need for a method and system to provide a better way of synchronizing contact information from multiple sources across multiple devices associated with a user.

### SUMMARY

Methods and systems for synchronizing contact information from multiple sources across multiple devices associated with a user are provided herein. In some embodiments, a method for synchronizing contact information across multiple devices associated with a user may include receiving a contact modification message from a first device to modify a contact in a cloud contact address book, where the cloud contact address book includes contact information for a plurality of contacts from one or more devices associated with a user; modifying the contact in the cloud address book based on modification information included in the contact modification message; identifying at least one device of the one or more devices in which the contact is a native contact; and pushing the modified contact to the identified at least one device.

In some embodiments, a method for updating a native contact on a device, where the native contact was modified in a cloud address book may include receiving a message indicating a change to the contact information associated with the native contact in the cloud contact address book, wherein the message includes a contact identifier that identifies the native contact; requesting, using the contact identifier, modified contact information associated with the native contact from the cloud address book; receiving the modified contact information; and updating the native contact in a native address book on the device using the modified contact information.

In some embodiments, a system for synchronizing contact information from multiple sources across multiple devices associated with a user may include a contact storage device that stores a cloud contact address book, wherein the cloud contact address book includes contact information for a plurality of contacts from one or more devices associated with the user; and a contact modification module configured to: receive a contact modification message from a first device to modify a contact in the cloud contact address book; modify the contact in the cloud contact address book based on modification information included in the contact modification message; identify at least one device of the one or more devices in which the contact is a native contact; and push the modified contact to the identified at least one device.

In some embodiments, a computer readable medium is disclosed. The computer readable medium stores computer instructions that, when executed by at least one processor causes the at least one processor to perform the method for synchronizing contact information from multiple sources across multiple devices associated with a user.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIGS. 2A and 2B collectively depict a block diagram of a system for synchronizing contact information from multiple sources across multiple devices associated with a user, according to one or more embodiments of the invention;

FIG. 3 depicts a flow diagram of a method for updating a contact in a cloud address book, according to one or more embodiments of the subject invention;

FIG. 4 depicts a flow diagram of a method for updating a native contact on a user device, according to one or more embodiments of the subject invention; and

FIG. 5 depicts a computer system that can be utilized in various embodiments of the present invention, according to one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to methods and systems for synchronizing contact information from multiple sources across multiple devices associated with a user. More specifically, embodiments of the present invention facilitate the synchronization and management of contact information stored on multiple different devices associated with a user using a configurable cloud/network based address book/contact directory associated with a user that is accessible from the multiple devices. The ability to modify contacts across devices advantageously provides users with a seamless contact information experience on each device where they login. That is, embodiments of the present invention allow a user to use a same address book across devices. In addition, embodiments of the present invention provide the user the ability to modify a contact in the address book from any device and have the contact automatically updated on the device or service where the contact is considered native. As used herein, synchronizing contact information/address books includes adding contact information, updating/modifying contact information, removing/deleting contact information, and the like.

For example, user X may own, or otherwise have access to, device A and device B, each of which have a unique native address book (e.g., native contacts A and native contacts B). The same mobile app, for example a Voice over Internet Protocol (VOIP) telecommunication app, may be installed on both devices. The native contact information stored on each device is sent to a network based contact management system (CMS). In some embodiments, the CMS may separately store each device's contact information (i.e., in separate address books) and also store a combined “cloud address book” for user X that may include at least some contacts from each of native contacts A and/or native contacts B. An identifier that uniquely identifies the device from where each contact is native is stored with the contact in the cloud address book. Thus, when user X accesses the mobile app from each device, the user has access to the local native address book and also to the network “cloud address book.”

When user X modifies a contact in the “cloud address book”, the source device on which the modified contact is native is identified. A message is sent to the identified source device to update the contact in the device's native contacts per the modification in the cloud address book. After the native contact has been updated on the source device, the native contact is synchronized with the owner of the contact per user settings on the source device. For example, if the native contact was obtained from an internet based address book/service (e.g., GOOGLE, YAHOO!), the modified contact is updated on the internet based address book/service systems via synchronization processes configured on the source device. As such, a user may modify a contact from any one of the user devices and have the modification reflect on the source device, as well as synced with the owner of the contact.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some exemplary embodiments described below are with respect to a mobile Voice over Internet Protocol (VOIP) telecommunication app. However, one skilled in the art will readily recognize from the following description that any application that relies on or uses address books/contact directories may be used in embodiments consistent with the present invention without departing from the principles of the disclosure described herein. For example, access to the cloud address book may be provided via a browser of a user device. When a contact is modified in the cloud address book, the change is further reflected on the user device where the contact is a native contact, and further synchronized with the “owner” of the contact, such as GOOGLE, YAHOO!, or Exchange.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

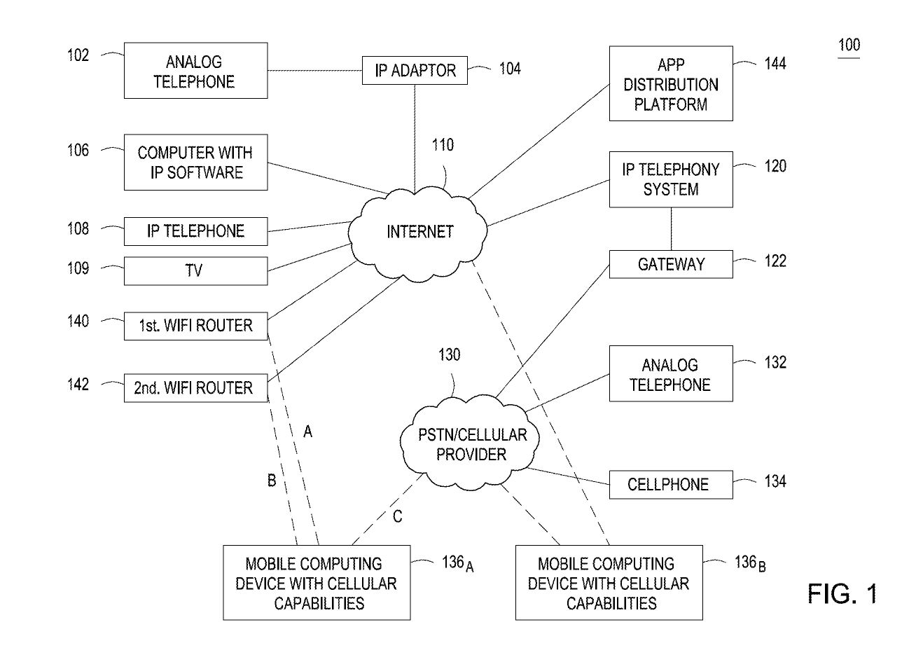

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136A (e.g., a smartphone) is capable of establishing a first wireless data connection A with a first wireless access point 140, such as a WiFi or WiMax router. The first wireless access point 140 is coupled to the Internet 110. Thus, the mobile computing device 136A can establish a VOIP telephone call with the IP telephony system 120 via a path through the Internet 110 and the first wireless access point 140.

FIG. 1 also illustrates that the mobile computing device 136A can establish a second wireless data connection B with a second wireless access point 142 that is also coupled to the Internet 110. Further, the mobile computing device 136A can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136A could also establish a VoIP telephone call with the IP telephony system 120 via the second wireless connection B or the third wireless connection C.

Although not illustrated in FIG. 1, the mobile computing device 136A may be capable of establishing a wireless data connection to a data network, such as the Internet 110, via alternate means. For example, the mobile computing device 136A might link to some other type of wireless interface using an alternate communication protocol, such as the WIMAX standard.

Similarly, mobile computing device with cellular capabilities 136B may also be coupled to internet 110 and/or cellular service provider 130. In some embodiments, mobile computing device 136B may be connected to internet 110 via a WIFI or WIMAX connection, and the like, and can also establish a VOIP telephone calls with the IP telephony system 120 similar to mobile computing device 136A. In embodiments of the present invention, communications environment 100 may be used to establish voice based or data based telecommunications sessions between mobile computing device 136A and mobile computing device 136B, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136A may download a VOIP mobile app from app distribution platform 144 and install the VOIP mobile app on mobile computing device 136A.

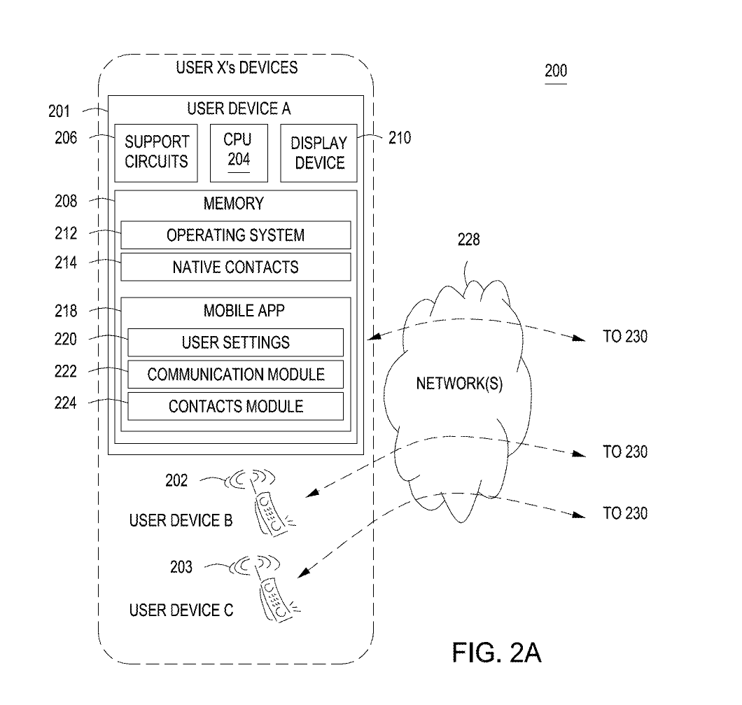

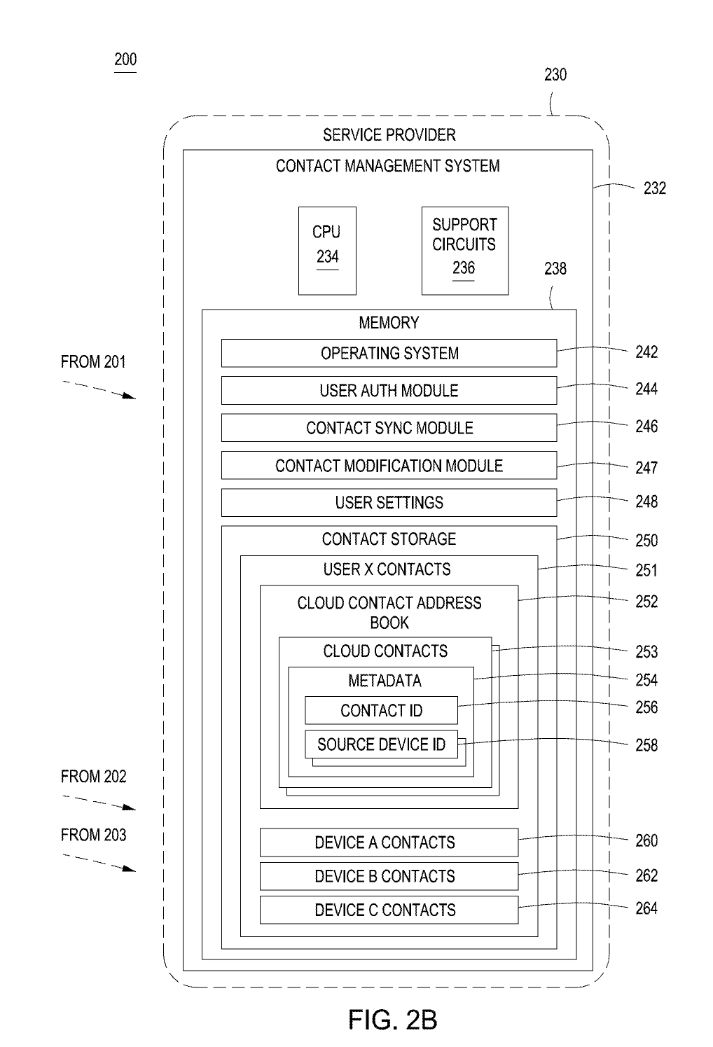

FIGS. 2A and 2B collectively depict a block diagram of a system 200 for synchronizing contact information from multiple sources across multiple devices associated with a user, according to one or more embodiments. The system 200 comprises multiple user devices, such as user devices 201, 202 and 203, and service provider system 230 communicatively coupled via networks 228. In some embodiments, user devices 201, 202 and 203 may be mobile computing devices (e.g., 136A) associated with a user, and service provider system 230 may be IP telephony system 120 as described above in FIG. 1.

Each user device 201, 202 and 203 may comprise a Central Processing Unit (CPU) 204, support circuits 206, memory 208, and a display device 210. The CPU 204 may comprise one or more commercially available microprocessors or microcontrollers that facilitate data processing and storage. The various support circuits 206 facilitate the operation of the CPU 204 and include one or more clock circuits, power supplies, cache, input/output device and circuits, and the like. The memory 208 comprises at least one of Read Only Memory (ROM), Random Access Memory (RAM), disk drive storage, optical storage, removable storage and/or the like. In some embodiments, the memory 208 comprises an operating system 212, native contacts 214 and a mobile app 218, such as a mobile telecommunication app.

The operating system (OS) 212 generally manages various computer resources (e.g., network resources, file processors, and/or the like). The operating system 212 is configured to execute operations on one or more hardware and/or software modules, such as Network Interface Cards (NICs), hard disks, virtualization layers, firewalls and/or the like. Examples of the operating system 212 may include, but are not limited to, various versions of LINUX, MAC OSX, BSD, UNIX, MICROSOFT WINDOWS, IOS, ANDROID and the like. In some embodiments, operating system 212 may include an application programming interface (API) which can be used to access and user device information and features (such as, for example, by mobile app 218).

The mobile app 218 may be any app that uses address book information. In some embodiments, the mobile app 218 is a VoIP app that provides over-the-top (OTT) VoIP telephony services to an end-user. In some embodiments, an end-user may download the mobile app 218 from service provider system 230, or from an app distribution system 144, and install the mobile app 218 on their device. Although the mobile app 218 is described herein as a separate stand-alone application, in some embodiments the mobile app 218 may be integrated into OS 212, and may use existing API calls provided by the OS 212 to access or control various features of user devices 202.

In some embodiments mobile app 218 may include user settings 220, a communication module 222, and a contacts module 224. In some embodiments, the user settings 220 may be used to determine how a user would like contact information synchronized or displayed, and may be used to manage privacy settings for the user (i.e., control which contacts will be synchronized with the contact management system 232). Communication module 222 may be used to facilitate, otherwise provide, communication services such as, for example, voice or video calling, SMS messages, email, or various other types of communication services provided by a service provider 230. In some embodiments, the contacts module 224 may be used to help manage, synchronize and display local and network contact information (i.e., an address book) and also to interface/communicate with a remote contact management system, such as, for example, contact management system 232. In some embodiments, communication module 222 and contacts module 224 may encrypt all or a portion of the information sent to remote servers/systems over network 228, or otherwise transmit the information in a secure format.

The networks 228 comprise one or more communication systems that connect computers by wire, cable, fiber optic and/or wireless link facilitated by various types of well-known network elements, such as hubs, switches, routers, and the like. The networks 228 may include an Internet Protocol (IP) network (such as internet 110 of FIG. 1), a public switched telephone network (PSTN) (such as the PSTN network of PSTN provider 130 of FIG. 1), or other mobile communication networks, and may employ various well-known protocols to communicate information amongst the network resources.

In some embodiments, service provider system 230 may be a communication service provider, such as a VoIP service provider, that includes and maintains contact management system 232. In other embodiments, contact management system 232 may be a separate entity that provides contact management services to service provider system 230, or to individual users, by agreement. Service provider system 230 may include contact management system 232 that may be used to manage/synchronize contacts across multiple devices associated with a user. The contact management system 232 may include a Central Processing Unit (CPU) 234, support circuits 236, and memory 238. The CPU 234 may comprise one or more commercially available microprocessors or microcontrollers that facilitate data processing and storage. The various support circuits 236 facilitate the operation of the CPU 234 and include one or more clock circuits, power supplies, cache, input/output circuits, and the like. The memory 238 comprises at least one of Read Only Memory (ROM), Random Access Memory (RAM), disk drive storage, optical storage, removable storage and/or the like. In some embodiments, the memory 238 comprises an operating system 242, user authentication module 244, contact sync module 246, contact modification module 247, user settings 248, and contact storage 250. The operating system (OS) 242 generally manages various computer resources (e.g., network resources, file processors, and/or the like). The operating system 242 is configured to execute operations on one or more hardware and/or software modules, such as Network Interface Cards (NICs), hard disks, virtualization layers, firewalls and/or the like. Examples of the operating system 242 may include, but are not limited to, various versions of LINUX, MAC OSX, BSD, UNIX, MICROSOFT WINDOWS, IOS, ANDROID and the like.

In some embodiments, contact storage 250 may store one or more address books for each user. For example, contact storage 250 may associate user identification information (i.e., a user/account identifier) with one or more individual contacts or groups of contacts that form one or more address books associated with the user. For example, as depicted in FIG. 2B, contact storage 250 may separately store user X's contacts/address books from user device A 201, user device B, 202, and user device C 203 as device A contacts 260, device B contacts, 262, and device C contacts 264, respectively. Additionally, contact storage 250 may store a cloud contact address book 252 that includes a plurality of cloud contacts 253₁₋ₙ that is a consolidated collection of one or more contacts from device A contacts 260, device B contacts, 262, and device C contacts 264. Each cloud contact 253₁, stored in cloud contact address book 252 includes metadata 254₁₋ₙ. Metadata 254₁₋ₙ includes a contact identifier 256 that uniquely identifies the contact 253₁₋ₙ and a source device identifier 258 that uniquely identifies the source device where the cloud contact 253₁₋ₙ is native. The source device identifier 258 may be an International Mobile Equipment Identity (IMEI), a media access control (MAC) address, or any identifier that uniquely identifies the source device where the contact is native. In addition, contact storage 250 may include an identifier for indicating whether the contact is a subscriber/customer of the service provider system 230. For example, in a VoIP system (e.g., service provider system 230 is a VoIP system), each contact may be marked as “on-net” indicating that the contact is a subscriber of VoIP service provider, or “off-net” indicating that the contact is not a subscriber of the VoIP service provider. Contact storage 250 may be any data structure or data source that maintains an association of contacts and user identifiers. The service provider system 230 may have direct or indirect access to contact storage 250. For example, contact storage 250 may exist on the service provider system 230 (direct access), or be accessible through a third party network (indirect access). For example, the service provider system 230 may be a VoIP service provider or a mobile app developer that provides OTT telephony services and may have agreements with trusted third-party providers to allow access to contact management system 232 and/or contact storage 250.

In operation, user X may use a mobile app 218 installed on user device A 201 to access service provider system 230 via network 228. The user authentication module 244 may perform authentication operations. Once user X is logged in, or otherwise authenticated, the contact sync module 246 may use native contact information 214 stored on device A, device B contact information 262, device C contact information 264, other user contact information and user settings information 248 to update, manage and/or synchronize the contacts 253₁₋ₙ in cloud contact address book 252 and the remote device A contacts 260 stored in contact storage 250 in the contact management system 232, as described in further detail in U.S. patent application Ser. No. 14/169,231, titled “Method and Systems for Syncing Contacts on Multiple Devices”, filed on Jan. 31, 2014, which is herein incorporated by reference in its entirety.

Contact modification module 247 may then provide access to the common cloud contact information (i.e., cloud contacts 252) to user device A 201, user device B 202 and user device C 203 associated with user X, such that a seamless address book/contact information experience is provided to user X on each device where they login. As such, contacts that are native to user device B 202 and user device C 203 are visible contacts that are native to user device A 201, in an aggregated view on user device A 201. The user may modify (i.e., change or delete), a contact in the aggregated view. For example, a user may click on the contact and modify a name, phone number, or the like. Upon saving changes to the contact, for example, by selecting a “SAVE” button or a “DONE” button, the contact information of the corresponding cloud contact 253₁₋ₙ is updated in the cloud contact address book 252. The contact modification module 247 accesses the metadata 254₁₋ₙ associated with the cloud contact 253₁₋ₙ to determine the source device identifier 258 that is associated with the modified cloud contact 253₁₋ₙ. The source device identifier 258 identifies one or more user devices, for example user device A 201, user device B 202, and/or user device C 203 where the contact is native. The contact modification module 247 then pushes the modified contact to the source device(s) based on the source device ID 258. Upon receipt of the contact, the contacts module 224 on the user device associated with the source device ID 258 updates the contact in the device's native contacts 214. The modified contact is further updated on the server of the owner of the contact per synchronization settings predefined for the owner of the contact. For example, a user device may be programmed to synchronize contacts daily with each contact owner, for example, GOOGLE or YAHOO!. At a predetermined time, the synchronization process for each contact owner updates contacts on the owner server per any modifications made to contacts on the user device.

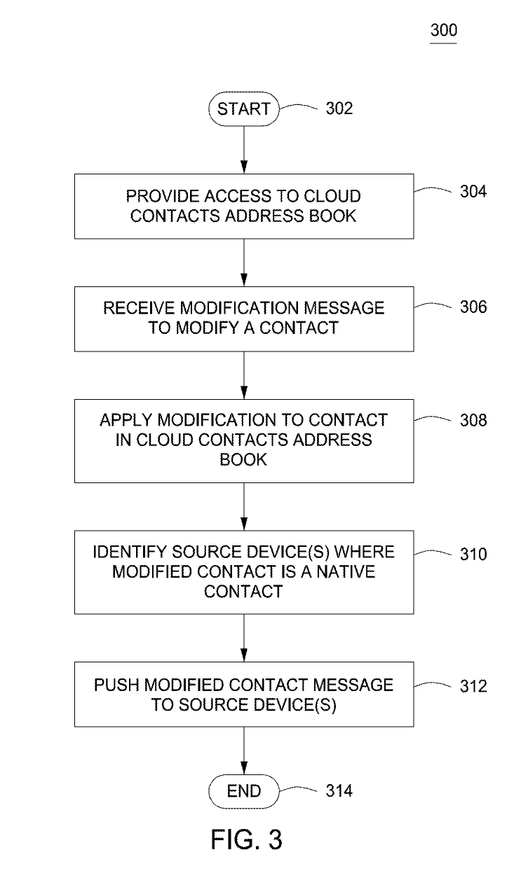

FIG. 3 depicts a flow diagram of a method 300 for updating a contact in a cloud address book, according to one or more embodiments of the subject invention. The method 300 starts at step 302 and proceeds to step 304, where a first device 201 is provided access to the cloud contact address book 252. In some embodiments, the access to the cloud contact address book 252 is provided in response to a request received from a mobile app (e.g., mobile app 218) running on the first device 201, and after the first device 201 has been authorized to access the cloud contact address book 252. In some embodiments, providing access to the cloud contact address book 252 includes sending information in association with the cloud contact address book 252 to the first device 201 (e.g., contact information, synchronization information, etc.). A cloud contact address book is an aggregated list of native contacts from all address books across multiple devices of the user. When a mobile communication app is launched from a user device and authenticated, for example a Voice over Internet Protocol (VoIP) telecommunication app, the native contacts on the given device from which the app is launched may be synchronized with the cloud contacts on the service provider's contact management system 232.

At step 306, a modification message including information to modify a contact in the cloud address book is received. Specifically, in some embodiments, the modification message may be sent by the user device from which the contact was updated. For example, when a user accesses the cloud contact address book on a user device from a mobile app, and performs a modification on a contact displayed in the mobile app, a modification message/signal indicating the changes will be sent to the CMS. In some embodiments, the modification message/signal may be a HyperText Transfer Protocol (HTTP) message or any TCP protocol, such as FTP, SMTP, IMAP, and the like. In some embodiments, the modifications specified in the modification message may include changes (revision, addition, deletion, etc.) to any information associated with the contact. In some embodiments, the modifications may include adding or deleting the entire contact. The method 300 proceeds to step 308, where the modification is applied to the contact in the cloud contact address book. The modification message is parsed to extract a contact identifier that uniquely identifies the contact. The cloud contact address book is searched using the contact identifier. The modifications specified in the modification message are applied to the information for the contact in the cloud contact address book. The method 300 proceeds to step 310.

At step 310, one or more source devices of the modified contact are identified. The source device is the device on which the contact is a native contact. Each contact in the cloud contact address book includes a source device identifier that uniquely identifies each of one or more devices on which the contact is native. The source device identifier may be an International Mobile Equipment Identity (IMEI), a media access control (MAC) address, a Unique Device Identifier (UDID), and ANDROID ID, a Mobile Equipment Identifier (MEID), or any identifier that uniquely identifies the source device where the contact is native.

The method 300 proceeds to step 312, where the modified contact is pushed to the identified source device in a message. In some embodiments, a contact identifier associated with the modified contact is retrieved from the cloud contact address book and included in the message. The contact identifier uniquely identifies the modified contact. In some embodiments, the modified contact information is included in the message. The message may be pushed to the identified source device using HTTP, SIP, or other protocol to transmit the message. The mobile app on each of the identified one or more source devices is sent the message instructing the mobile app to update the contact. In some embodiments, the service provider may call an API built into the operating system of the source device to place the modified contact back into a native address book. The message instructs the source device to update the contact in the native address book of the source device so as to reflect the modification made in the cloud address book. In some embodiments, a confirmation message or ACK message is received from the source device indicating that the modification to the native address book was successful. The method 300 ends at 314.

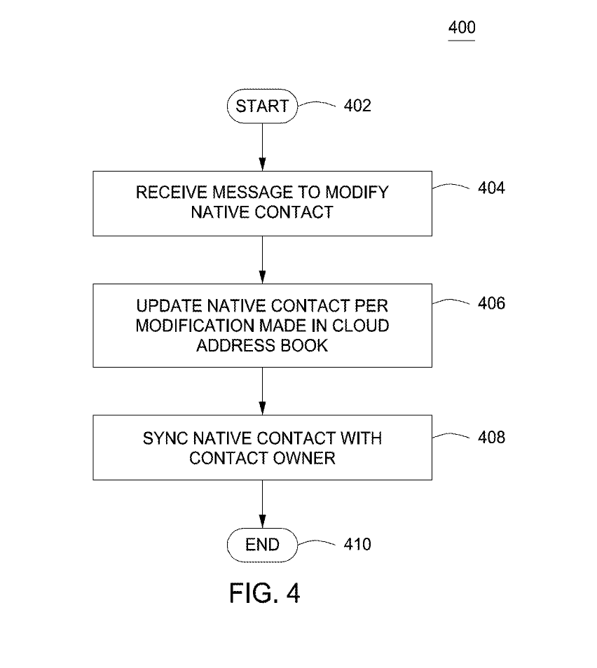

FIG. 4 depicts a flow diagram of a method 400 for updating a native contact on a user device, according to one or more embodiments of the subject invention. In the embodiments consistent with FIG. 4, the native contact was first modified in a cloud address book, where the cloud address book is an aggregate of native address books on multiple devices associated with a user. The method 400 starts at step 402 and proceeds to step 404 where a message is received via a mobile app, for example a Voice over Internet Protocol (VoIP) telecommunication app, instructing the modified contact to be updated in the native address book of the user device. In some embodiments, the user device polls the service provider for modifications to contacts in the cloud address book and the message is received in response to polling the service provider. At step 406, the native contact is updated per the modification in the cloud address book. In some embodiments, an API, for example a get contact API is used to retrieve contact information of the modified contact from the cloud address book. In some embodiments, where the modified contact information is included in the message, the native contact is updated based on the information received in the message. The retrieved information is used to update the native contact on the user device.

At step 408, the updated native contact is synced with the owner of the native contact. For example, the native contact may be a GOOGLE GMAIL contact, a YAHOO contact, or any contact owned by any originating application. Once stored in the native address book, the updated native contact is automatically synced with the contact owner per default settings on the user device. The method 400 ends at step 410.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

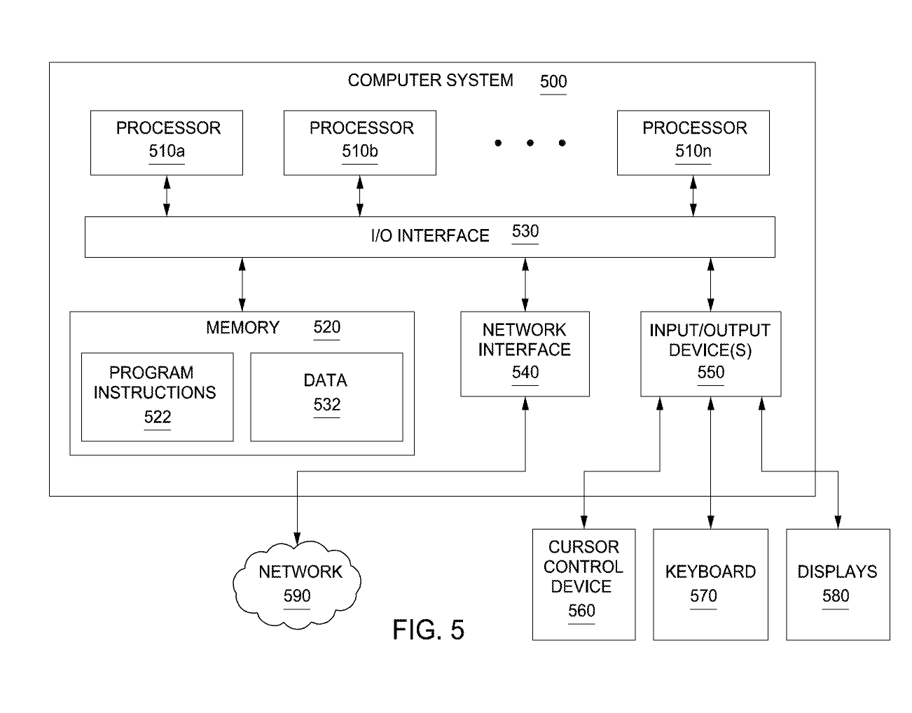

FIG. 5 depicts a computer system 500 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments. In the illustrated embodiments, computer system 500 may be configured to implement the methods 300 and 400 as processor-executable executable program instructions 522 (e.g., program instructions executable by processor(s) 510) in various embodiments.

In the illustrated embodiment, computer system 500 includes one or more processors 510a-510n coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs). In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the operations and methods described above, such as the methods illustrated by the flowcharts of FIG. 3 and FIG. 4. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for synchronizing contact information across multiple devices associated with a user, comprising:
receiving a contact modification message from a first device to modify a contact in a cloud contact address book, where the cloud contact address book includes contact information for a plurality of contacts from one or more devices associated with a user;
modifying the contact in the cloud address book based on modification information included in the contact modification message;
identifying at least one device of the one or more devices in which the contact is a native contact; and
pushing the modified contact to the identified at least one device.

2. The method of claim 1, wherein some of the plurality of contacts from a first device in the one or more devices are unique from some of the plurality of contacts from a second device in the one or more devices.

3. The method of claim 1, wherein at least some of the plurality of contacts stored in the cloud contact address book is owned by a third party application.

4. The method of claim 1, wherein identifying at least one device comprises:
determining, from metadata associated with the contact in the cloud contact address book, at least one source device identifier that uniquely identifies the at least one device on which the contact is a native contact.

5. The method of claim 1, wherein pushing the modified contact comprises:
determining, from metadata associated with the contact in the cloud address book, a contact identifier that uniquely identifies the modified contact; and
sending a message to the at least one identified device including the at least the contact identifier and the modification information.

6. The method of claim 1, wherein a native contact is a contact that is stored locally on a device of the one or more devices associated with the user.

7. A computer implemented method for updating a native contact on a device, wherein contact information associated with the native contact was modified in a cloud contact address book, comprising:
receiving a message indicating a change to the contact information associated with the native contact in the cloud contact address book, wherein the message includes a contact identifier that identifies the native contact;
requesting, using the contact identifier, modified contact information associated with the native contact from the cloud address book;
receiving the modified contact information; and
updating the native contact in a native address book on the device using the modified contact information.

8. The method of claim 7, wherein the native contact is owned by a third party application.

9. The method of claim 8, further comprising synchronizing the updated native contact with the third party application that owns the native contact.

10. A system for synchronizing contact information across multiple devices associated with a user, comprising a contact storage device that stores a cloud contact address book, wherein the cloud contact address book includes contact information for a plurality of contacts from one or more devices associated with the user; and
a contact modification module configured to:
receive a contact modification message from a first device to modify a contact in the cloud contact address book;
modify the contact in the cloud contact address book based on modification information included in the contact modification message;
identify at least one device of the one or more devices in which the contact is a native contact; and
push the modified contact to the identified at least one device.

11. The system of claim 10 further comprising a contacts module configured to:
receive a message to update the native contact;
identify a contact identifier from the message;
request, using the contact identifier, contact information for the native contact from the cloud contact address book; and
update the native contact in a native address book on the at least one device.

12. The system of claim 10, wherein at least some of the plurality of contacts stored in the cloud contact address book are owned by a third party application.

13. The system of claim 10, wherein identifying at least one device comprises:
determining, from metadata associated with the contact in the cloud contact address book, at least one source device identifier that uniquely identifies the at least one device on which the contact is a native contact.

14. The system of claim 10, wherein pushing the modified contact comprises:
determining, from metadata associated with the contact in the cloud address book, a contact identifier that uniquely identifies the modified contact; and
sending a message to the at least one identified device including at least the contact identifier and the modification information.

15. A non-transitory computer readable medium for storing computer instructions that, when executed by at least one processor causes the at least one processor to perform a method for synchronizing contact information across multiple devices associated with a user, comprising:
receiving a contact modification message from a first device to modify a contact in a cloud contact address book, where the cloud contact address book includes contact information for a plurality of contacts from one or more devices associated with a user;
modifying the contact in the cloud contact address book based on modification information included in the contact modification message;
identifying at least one device of the one or more devices in which the contact is a native contact; and
pushing the modified contact to the identified at least one device.

16. The computer readable medium of claim 15, wherein one or more of the plurality of contacts from a first device in the one or more devices are unique from one or more of plurality of contacts from a second device in the one or more devices.

17. The computer readable medium of claim 15, wherein at least some the plurality of contacts stored in the cloud contact address book is owned by a third party application.

18. The computer readable medium of claim 15, wherein identifying at least one device comprises:
determining, from metadata associated with the contact in the cloud contact address book, at least one source device identifier that uniquely identifies the at least one device on which the contact is a native contact.

19. The computer readable medium of claim 15, wherein pushing the modified contact comprises:
determining, from metadata associated with the contact in the cloud address book, a contact identifier that uniquely identifies the modified contact; and
sending a message to the at least one identified device including at least the contact identifier and the modification information.

20. The computer readable medium of claim 15, wherein a native contact is a contact that is stored locally on a device of the one or more devices associated with the user.
